(19) United States
(12) Patent Application Publication
(10) Pub. No.: US 2015/0321756 A1
(43) Pub. Date: Nov. 12, 2015

(54) Rotor Head of Remote Control Helicopter and Remote Control Helicopter

(71) Applicant: Hirobo Co., Ltd., Fuchu-shi (JP)

(72) Inventor: Takakazu Uebori, Fuchu-shi (JP)

(73) Assignee: Hirobo Co., Ltd., Fuchu-shi (JP)

(21) Appl. No.: 14/272,926

(22) Filed: May 8, 2014

(51) Int. Cl. B64C 27/78; B64C 27/56; B64C 27/82; B64C 27/10; B64C 27/12

(52) U.S. Cl. CPC B64C 27/78; B64C 27/10; B64C 27/12; B64C 27/82; B64C 27/56

(57) ABSTRACT

To further stabilize the flight operation of an R/C helicopter, thereby improving operability, based on the finding that a position of appearance of gyro precession is different from the conventional R/C helicopter. A rotor head of a coaxial counter-rotating R/C helicopter is configured so that upper and lower main rotors MR are provided, in response to gyro precession of the main rotors as an output to an operation input from the swash plates appears within a range smaller than 90°, mounting positions of the upper and lower main rotors are provided to become an angle smaller than 90° around the main masts and with respect to the input positions of each of cyclic controls to upper and lower main rotors using the upper and lower swash plates, and the upper and lower main rotors and the upper and lower swash plates are connected via a link mechanism.

### BACKGROUND OF THE INVENTION

1. Field of the Invention

The present invention relates to a structure of a rotor head of a remote control helicopter (hereinafter, generally referred to as an R/C helicopter) that flies by a wireless remote control (Radio Control).

2. Description of Related Art

The R/C helicopter generates lift by rotating main rotor blades with an angle of attack, transmits a tilting motion of a swash plate attached to a base portion of a main mast to the main rotor blades via a link mechanism, and generates a thrust in a tilting direction to fly by tilting a rotary surface of a rotor using a change in the lift due to a change in the angle of attack.

Controlling the rotary surface of the main rotor so as to tilt in the same direction as the swash plate by the tilting motion of the swash plate is due to the action of a gyro precession in which when force is applied on a rotating object, the effect of force appears in a direction in which the rotation of 90° advances. In order to cause the main rotor and a stabilizer to function to control the external stress applied to an aircraft and stabilize the flight operation by the gyro precession effect, the main rotor is provided in an arrangement in which a phase difference of the output to the operation input of the swash plate becomes 90°.

That is, in general, an outdoor single rotor type R/C helicopter has a configuration in which gyro precession appears to be delayed by 90° with respect to an input, and using this, a rudder is input to a position delayed by 90° with respect to the rotary direction of a main rotor, that is, a swash plate is tilted at a position delayed by 90°, thereby changing a pitch angle of the main rotor.

Furthermore, as illustrated in FIG. 8, a coaxial counter-rotating R/C helicopter equipped with upper and lower main rotors rotating in directions opposite to each other is also configured so that upper and lower main rotors 102 and 102 attached to a main mast 101 are disposed to have a phase difference of 90° around the main mast 101 with respect to output parts 100a and 100b of a swash plate 100 (for example, see Patent Document 1).

Furthermore, in a single rotor type R/C helicopter miniaturized for indoor use, when lightweight rotor blades of a main rotor are formed using a plastic material such as styrene foam, it was found that the position of appearance of the gyro precession appears within a range smaller than 90° with respect to an operation input of a swash plate, and in response to this, a configuration of the indoor R/C helicopter, in which the main rotor and the stabilizer are attached to rotate while maintaining a phase difference of an acute angle, thereby improving operability and stability of the flight, has been known (see, for example, Patent Document 2)

### RELATED ART

### Patent Document

[Patent Document 1] JP 63-272381 A

[Patent Document 2] Japanese Patent No. 4249801

### SUMMARY OF THE INVENTION

A flight principle of the R/C helicopter is based on the same helicopter engineering as an actual helicopter, and similarly to the actual helicopter, even in the R/C helicopter, in order to stabilize the flight operation using the gyro precession effect, a main rotor is provided in an arrangement in which the phase difference of the output with respect to the operation input of the swash plate is 90°.

However, after it has been found that the gyro precession appears at an unusual position in the indoor R/C helicopter, in order to improve operability and flight stability of the R/C helicopters other than the indoor use, the present applicant has verified the correct position where the gyro precession appears and it has been found that, in regard to various types R/C helicopter regardless of the indoor use or the outdoor use, regardless of the weight of the main rotor blades, that is, even when the main rotor blades are made of wood or FRP and have high rigidity and large weight, and even in a single-rotor type R/C helicopter with a stabilizer, an R/C helicopter having no stabilizer, and a coaxial counter-rotating R/C helicopter having the main rotors disposed up and down, the gyro precession appears within a range smaller than 90° with respect to the operation input from the swash plate.

A reason why the gyro precession appears at a position different from the theory of helicopter engineering is not clear yet, but the present inventor has confirmed that regarding the rotor head of the R/C helicopter, when the aircraft is configured to cope with the appearance of the gyro precession of the main rotor within the range smaller than 90° with respect to the operation input from the swash plate, that is, when the position of the operation input of the swash plate relative to the main rotor is appropriately adjusted around the main mast, or the mounting position around the main mast of the main rotor is appropriately adjusted to configure the aircraft, the operability and flight stability of the R/C helicopter become extremely excellent compared to the related art. In the conventional R/C helicopter, even if the main rotor was not disposed at the correct position where the gyro precession appears, it was believed that the flight operation is stabilized by forcibly correcting the behavior of the aircraft by changing the shapes of the blades of the main rotor and the stabilizer or by precisely adjusting a Bell-Hiller rate of the rotor head and characteristics of the control signals that are output from other adjustment positions and a transmitter.

An object of the present invention is to further stabilize the flight operation of the R/C helicopter than the related art, thereby improving the operability, based on the finding that a position of appearance of the gyro precession is different from the conventional R/C helicopter.

According to an aspect of the invention for solving the above-described problems, there is provided a rotor head of a remote control helicopter that flies by changing an angle of attack of rotor blades of a main rotor attached to a main mast by performing a tilting operation of a swash plate by a wireless remote control, in which the main rotor is provided so that gyro precession of a main rotor serving as an output with respect to an operation input from the swash plate appears within a range smaller than 90°, and the rotor head has a configuration in which a mounting position of the main rotor is provided at an angle smaller than 90° around the main mast with respect to an input position of a cyclic control to the main rotor using the swash plate, and the main rotor and the swash plate are connected via a link mechanism so that an angle of intersection in a plan view between a line segment in a long axis direction of the main rotor and a position of the operation input of the swash plate that is input via the link mechanism connected to the main rotor becomes an acute phase angle α.

Furthermore, according to another aspect of the invention, there is provided a rotor head of a coaxial counter-rotating remote control helicopter in which upper and lower main rotors are attached to a rotary shaft provided on a main mast and coaxially counter-rotating to each other, and which flies by changing an angle of attack of rotor blades of the upper and lower main rotors by performing a tilting operation of each of upper and lower swash plates by a wireless remote control, in which the upper and lower main rotors are provided so that gyro precession of the respective main rotors serving as an output with respect to an operation input from the upper and lower swash plates appears within a range smaller than 90°, and the rotor head has a configuration in which mounting positions of the upper and lower main rotors are provided to an angle smaller than 90° around the main mast with respect to the input positions of each of cyclic controls of upper and lower main rotors using the upper and lower swash plates, and the upper and lower main rotors and the upper and lower swash plates are connected via a link mechanism, respectively so that an angle of intersection in a plan view between line segments of a long axis direction of each of upper and lower main rotors and a position of the operation inputs of the upper and lower swash plates that are input via the link mechanism connected to each of the upper and lower main rotors becomes an acute phase angle α, respectively.

Furthermore, according to an aspect of the invention, provided is an R/C helicopter that includes the rotor head having the configuration described above.

The rotor head of the above-described configuration is also applicable to a single rotor type R/C helicopter having a stabilizer, an R/C helicopter having no stabilizer, and a coaxial counter-rotating R/C helicopter.

A single-rotor type R/C helicopter having a stabilizer, an R/C helicopter having no stabilizer, and a coaxial counter-rotating R/C helicopter equipped with the rotor head of the present invention were each configured, and each R/C helicopter was allowed to fly by the remote control. In all R/C helicopters, it was confirmed that the aircraft keeps the stabilized flight attitude, the flight attitude does not collapse even if the flight direction changes, the behavior of the aircraft is also stable and the aircraft can smoothly fly in a desired direction, and the operability is dramatically improved.

According to the invention, by providing a configuration in which the rotor head of the R/C helicopter is attached to the main mast by adjusting the phase angle of the main rotor with respect to the operation input from the swash plate to a range of an acute angle rather than 90°, even if various setting positions of the aircraft and the transmitter are not precisely adjusted, it is possible to stabilize the flight operation of the R/C helicopter, thereby dramatically improving the operability.

### BRIEF DESCRIPTION OF THE DRAWINGS

FIG. 1 is a front view of a state in which rotor blades of an R/C helicopter equipped with rotor head of an exemplary embodiment in the present invention project to right and left sides of an aircraft, and a side view of a state in which the rotor blades project to front and rear sides of the aircraft.

FIG. 2 is an enlarged external perspective view as a front perspective view and a rear perspective view of the aircraft of a state in which a cowl of the R/C helicopter of FIG. 1 is removed.

FIG. 3 is an external perspective view of the rotor head illustrating an enlarged lower main rotor side of the aircraft of FIG. 2.

FIG. 4 is an external perspective view of the rotor head illustrating an enlarged upper main rotor side of the aircraft of FIG. 2.

FIG. 5 is an external view of the upper main rotor portion of a state of removing the rotor blades of the aircraft of FIG. 2.

FIG. 6 is a schematic transverse cross-sectional view of the aircraft of FIG. 2 (break line is omitted for clarity).

FIG. 7 is a diagram illustrating an arrangement relation between an input position of a cyclic control of a swash plate around the main mast and the main rotors, FIG. 7(A) illustrates a conventional rotor head, and FIG. 7(B) illustrates a rotor head of the present invention.

FIG. 8 is a diagram illustrating a configuration of a rotor head of a conventional coaxial counter-rotating R/C helicopter.

### DESCRIPTION OF THE INVENTION

A preferred embodiment of the invention will be described with reference to the drawings.

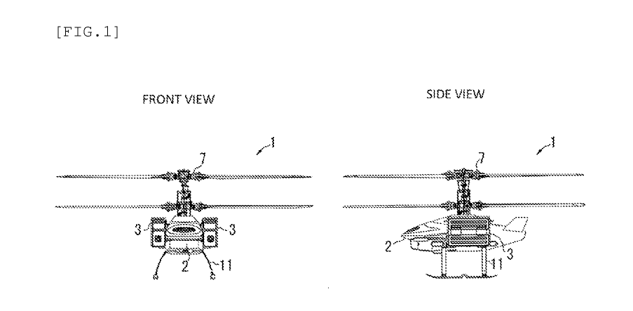

FIG. 1 illustrates an external form of an R/C helicopter equipped with a rotor head of an embodiment of the invention. As illustrated, the present embodiment is an application of the invention to a coaxial counter-rotating R/C helicopter having upper and lower main rotors that coaxially counter-rotate to each other. In FIG. 1, reference numeral 1 is an R/C helicopter, 2 is a cowl, and 3 is a battery that drives an electric motor to be described later.

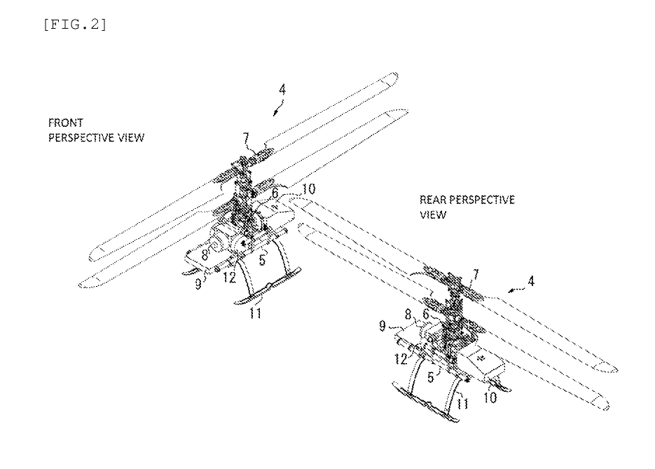

FIG. 2 illustrates an external form of a front side and a rear side of an aircraft of the R/C helicopter 1 in a state of removing the cowl 2. As illustrated in FIG. 2, an aircraft 4 is configured so that respective unitized members, such as a gearbox unit 6 formed by assembling an electric motor 8 to a rotor head 7 to which the upper and lower main rotors are attached, a motor control box 9 in which a control circuit of the electric motor 8 is housed, a servo control box 10 in which control circuits of each servo are housed, skids 11, and a receiver of a steering signal (not illustrated) are integrally attached to an aircraft frame 5 configured by assembling pipes made of aluminum in a frame shape. Reference numeral 12 is a ducted motor cover which accommodates a motor fan for cooling the electric motor 8 therein.

As illustrated in FIGS. 3 to 6, the rotor head 7 is configured to include members such as a main mast 13, upper and lower main rotors 14 and 15, swash plates 16 and 17, an elevator servo ES, an aileron servo AS, a pitch servo PS, and a rudder RS, and rods that connect actuating units of these members to one another to constitute a link mechanism.

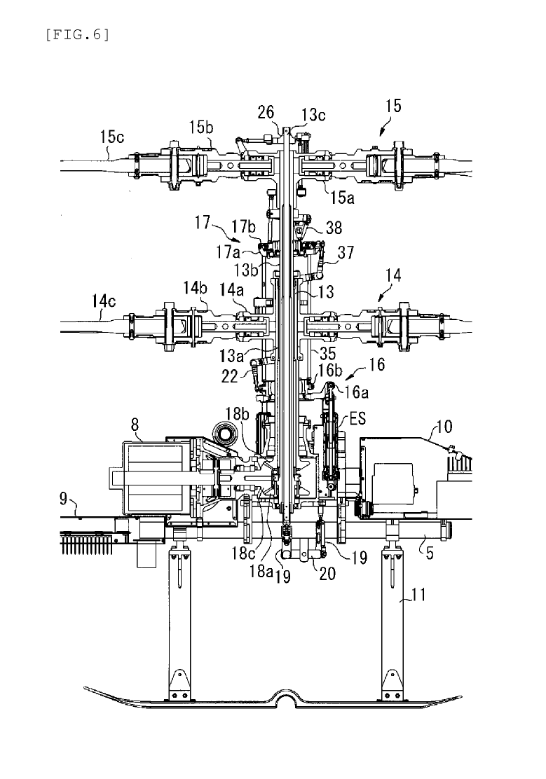

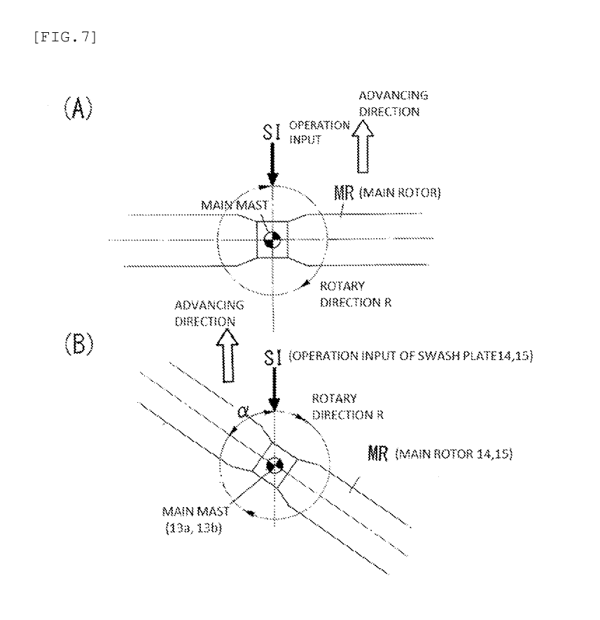

Specifically, the main mast 13 is configured so that an upper main mast 13b longer than a hollow lower main mast 13a is mounted on the interior of the hollow lower main mast 13a and is coaxially disposed, as illustrated in FIG. 6, bevel gears 18a and 18b fixed to each of lower end portions of both masts are engaged and connected to a bevel gear 18c fixed to an output shaft of the electric motor 8 installed below the main mast 13, and both masts rotate in opposite directions to each other by driving the electric motor 8.

A rudder mixing rod 13c is slidably inserted into the upper main mast 13b along an inner circumferential surface of the upper main mast 13b, the upper end portion of the rudder mixing rod 13c projects above the main mast 13, a mixing rod head 26 to be described later is integrally fixed thereto, and an end portion of a rudder push-pull arm 19 is connected to a lower end portion thereof via a bearing.

The mixing rod head 26 is attached to the upper main rotor 15 via a rudder stopper plate 31 and an adjusting rod 28 that will be described later, and rotates integrally with the upper main rotor 15 within the main mast 13.

The other end portion of the rudder push-pull arm 19 is pivotally supported at one end portion of a rudder mixing arm 20 attached below the main mast 13 in a state in which a center thereof is rotatably pivotally supported, the other end portion of the rudder mixing arm 20 is connected to the other end portion of the rudder push-pull arm 19, one end of which is connected a downward output lever 34 connected to the servo horn of the rudder servo RS (see FIG. 6).

As illustrated in FIG. 3, the lower main rotor 14 is constituted by a lower yoke 14a integrally fixed to an outer periphery of the lower main mast 13a, a pair of lower blade holders 14b and 14b rotatably attached to both right and left sides of the lower yoke 14a about an axial direction perpendicular to the main mast 13, and lower rotor blades 14c and 14c that are integrally attached to the lower blade holders 14b and 14b at a predetermined pitch angle by interposing between the base end portions of the lower blade holders 14b and 14b from both upper and lower surfaces and allowing a bolt to pass therethrough.

The lower york 14a is integrally fixed with a lower radius block 21 on a circumferential surface portion of the lower yoke 14a integrally fixed to an outer circumferential surface of the lower main mast 13a, and a lower radius arm 22 connected to the lower radius block 21 is integrally connected to a lower rotary swash 16b of a lower swash plate 16 to be described later.

Furthermore, end portions of mixing arm lowers 23 and 23 rotatably attached to the lower yoke 14a about the axial direction perpendicular to the mast 13 as a fulcrum are rotatably connected to the lower blade holders 14b and the 14b respectively, via the lower pitch arm 24.

The other end portions of the mixing arm lowers 23 and 23 are connected to the upper end portions of the adjusting rods 25 and 25 vertically disposed parallel to the mast 13, and the lower end portions of the adjusting rods 25 and 25 are connected to the lower rotary swash 16b of the lower swash plate 16.

The lower main rotor 14 is configured so that the tilting motion of the lower swash plate 16 to be described later is transmitted to the lower blade holders 14b and 14b via the adjusting rod 25, the mixing arm lower 23, and the lower pitch arm 24, while rotating integrally with the lower main mast 13a, and the entire lower main rotor 14 is appropriately tilted in accordance with titling of the lower blade holders 14b and 14b about the axis direction perpendicular to the main mast 13, thereby changing the pitch angle of the lower rotor blades 14c and 14c.

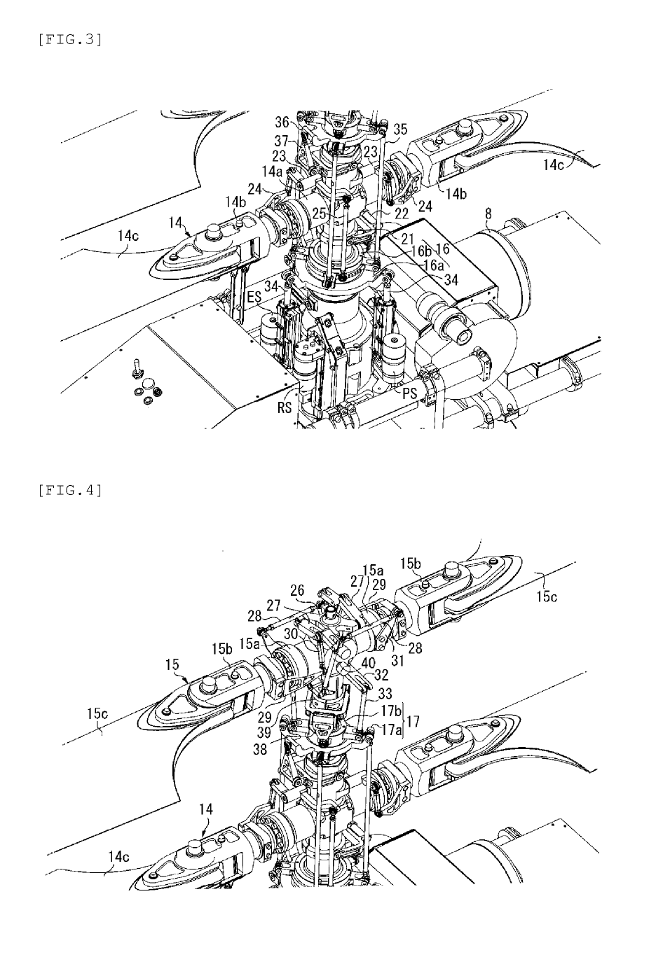

As illustrated in FIG. 4, the upper main rotor 15 is configured in the same manner as the lower main rotor 14, by an upper yoke 15a integrally fixed to the outer periphery of the upper main mast 13b, a pair of upper blade holders 15b and 15b attached to both right and left sides of the upper yoke 15a so as to be freely rotatable around the axial direction perpendicular to the main mast 13, and upper rotor blades 15c and 15c integrally attached to the upper blade holders 15b and 15b at a predetermined pitch angle by interposing the base end portions of the upper blade holders 15b and 15b from both upper and lower surfaces and allowing a bolt to pass therethrough.

Above the upper main rotor 15, the mixing rod head 26 is attached to the end portion of the rudder mixing rod 13c protruding from the upper end of the main mast 13. Upper mixing arms 27 and 27 are attached to both right and left sides of the mixing rod head 26 positioned above the upper yoke 15a so as to be freely rotatable about the axis direction, as a fulcrum, perpendicular to the mast 13. Furthermore, the adjusting rods 28 and 28, which are freely rotatable about the axial direction, as a fulcrum, perpendicular to the mast 13 and disposed along the axial direction of the upper main rotor 15, are attached to both front and rear sides of the mixing rod head 26.

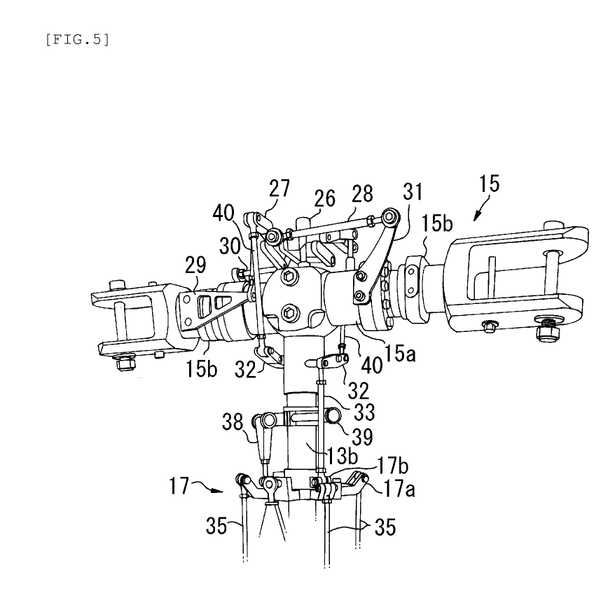

Upper pitch arms 29 and 29 are attached to one side of the upper blade holders 15b and 15b, and the end portion of the upper pitch arm 29 is connected to a shaft unit provided in an intermediate portion of the mixing arm upper 27 via an adjusting rod 30. Furthermore, as illustrated in FIG. 5, a rudder stopper plate 31 is attached to the upper yokes 15a and 15a, and the other end portion of the adjusting rod 28 connected to the mixing rod head 26 at one end is connected to the end portion of the rudder stopper plate 31. The rudder stopper plate 31 and the adjusting rod 28 have also a function that supports the mixing rod head 26 so that the mixing rod head 26 moving up and down along the main mast 13 is not twisted by force exerted with the rotation of the main mast 13 during flight.

Furthermore, the end portions of the mixing arm uppers 27 and 27 are connected to the mixing arm upper 32 pivotally supported on the outer circumferential surface of the upper yoke 15a via the adjusting rod 40, and the mixing arm upper 32 is connected to an upper top rotary swash 17b of an upper swash plate 17 to be described later via an adjusting rod 33 that is pivotally supported to the end portion.

The upper main rotor 15 is configured so that the tilting motion of the upper swash plate 17 to be described later is transmitted to the upper blade holders 15b and 15b via the adjusting rod 33, the mixing arm upper 32, the upper mixing arm 27, and the upper pitch arm 29, while rotating integrally with the upper main mast 13b, and the entire upper main rotor 15 is appropriately tilted in accordance with titling of the upper blade holders 15b and 15b about the axis direction perpendicular to the main mast 13, thereby changing the pitch angle of the upper rotor blades 15c and 15c.

Furthermore, in the upper main rotor 15, when actuating the rudder servo RS to move the rudder mixing rod 13c up and down along the mast 13, the rudder mixing rod 13c and the mixing rod head 26 fixed to the upper end of the rudder mixing rod 13c are vertically displaced, and the upper mixing arms 27 and 27 vertically rotate about the portion, as a fulcrum, attached to the mixing rod head 26 in response to the displacement. Moreover, the displacement of the rotating upper mixing arms 27 and 27, and the input from the upper top rotary swash 17b to be described later are mixed with each other and are transmitted to the upper blade holders 15b and 15b via the upper pitch arms 29 and 29 to change the pitch angle of the upper rotor blades 15c and 15c, thereby providing a difference between the pitch angle of the lower main rotor 14 so that the yaw axis control of the R/C helicopter 1 is performed.

As illustrated in FIG. 3, the lower swash plate 16 is configured so that the lower rotary swash 16b is rotatably supported on the upper side of the lower fixing swash 16a via a bearing (not illustrated). The main mast 13 passes through an opening formed in the center thereof and is tiltably mounted about the axis of the direction perpendicular to the mast around the mast.

Each servo of the an elevator servo ES, the aileron servo AS, and the pitch servo PS is installed below the lower swash plate 16, thereby connecting an upward output lever 34 connected to each of the servo horns to the outer circumferential three sides of the lower fixing swash 16a, respectively.

The lower rotary swash 16b is attached to the lower yoke 14a via the lower radius arm 22 and the upper radius block 21 to rotate integrally with the lower main mast 13a. Furthermore, the lower end portions of the adjusting rods 25 connected to the mixing arm lower 23 at the upper end portion are connected to the opposed positions of the outer circumferential surface of the lower rotary swash 16b, the lower end portions of the four adjusting rods 35 are connected to the outer circumferential four sides, and the upper end portions of the adjusting rods 35 are connected to the outer circumferential four sides of the upper bottom rotary swash 17a of the upper swash plate 17 to be described below.

As illustrated in FIG. 4, the upper swash plate 17 is configured so that the upper top rotary swash 17b is rotatably supported on the upper side of the upper bottom rotary swash 17a via a bearing (not illustrated). The main mast 13 passes through an opening formed at the center thereof and is tiltably attached about the axis of the direction perpendicular to the mast around the mast.

Furthermore, the outer circumferential four sides of the upper bottom rotary swash 17a are connected to the outer circumferential four sides of the lower rotary swash 16b via the adjusting rod 35, are fixed to the lower yoke 14a via the upper radius block 36 and the upper radius arm 37, and are attached so as to rotate integrally with the lower main rotor 14.

Furthermore, the upper top rotary swash 17b is fixed to the upper radius block 39 fixed to the outer circumferential surface of the upper main mast 13b via the upper radius arm 38 to rotate integrally with the upper main mast 13b along with the upper main rotor 15.

Furthermore, the lower end portions of the adjusting rod 33 connected to the mixing arm upper 32 at the upper end portion are connected to the opposed positions of the outer circumferential surface of the upper top rotary swash 17b, respectively.

In the lower swash plate 16 and the upper swash plate 17, when driving the elevator servo ES, the aileron servo AS, or the pitch servo PS to move up and down the upward output lever 34 connected to each servo horn, the lower fixing swash 16a and the lower rotary swash 16b of the lower swash plate 16 are tilted around the main mast 13 in response to the position of the output lever 34 moving up and down, and along with the tilting of the lower rotary swash 16b, the upper and lower rotary swashes 17a and 17b of the upper swash plate 17 are attached to tilt around the main mast 13 in parallel to the lower swash plate 16.

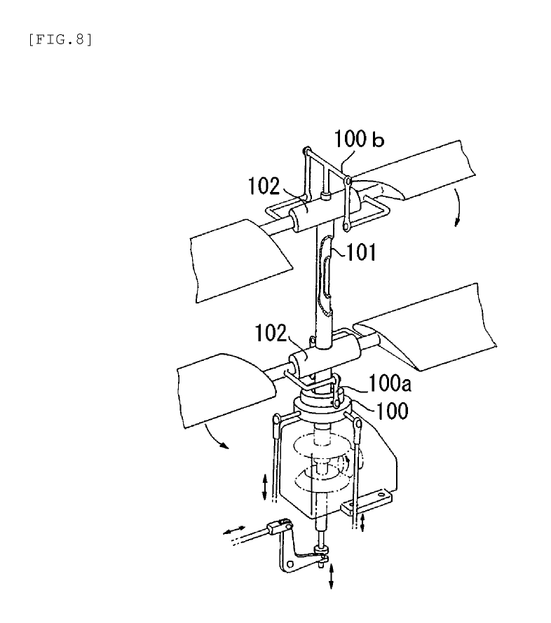

Furthermore, in the conventional R/C helicopter, as illustrated in FIG. 7(A), on the basis of the finding that the gyro precession appears to be delayed by 90° with respect to the input, the rudder is input at a position delayed by 90° with respect to the rotary direction R of the main rotor MR using this, that is, the swash plate is tilted at a position delayed by 90° with respect to the rotary direction of the main rotor MR, and the operation input SI is input to the main rotor MR via the adjusting rod to change the pitch angle of the main rotor MR.

In contrast, in the arrangement of the lower main rotor 14 and the lower swash plate 16 around the lower main mast 13a in this embodiment, on the basis of the finding that the gyro precession appears within a range smaller than 90°, in response thereto, as illustrated in FIG. 7(B), the mounting position of the lower main rotor 14 is provided to become an angle smaller than 90° around the lower main mast 13a with respect to the input position of the cyclic control to the lower main rotor 14 using the lower swash plate 16, that is, at the position where an angle of intersection in a plan view between line segments in the longitudinal axis direction of the lower main rotor 14 and the position of the operation input of the lower rotary swash 16b that is input to the lower main rotor 14 via the adjusting rod 25 becomes an acute phase angle α.

Moreover, the lower main rotor 14 and the lower rotary swash 16b are connected by the adjusting rod 25, and the operation input of the lower rotary swash 16b is input to the lower main rotor 14 at a position advanced by the acute phase angle α, thereby changing the pitch angle.

In addition, in the arrangement of the upper main rotor 15 and the upper swash plate 17 around the upper main mast 13b, in the same manner as described above, the mounting position of the upper main rotor 15 is provided to become an angle smaller than 90° around the upper main mast 13b with respect to the input position of the cyclic control using the upper swash plate 17, and an angle of intersection in a plane view between the line segments in the longitudinal axis direction of the upper main rotor 15 and the position of the operation input of the upper top rotary swash 17b that is input to the upper main rotor 15 via the adjusting rod 33 becomes the acute phase angle α.

Moreover, the upper main rotor 15 and the upper top rotary swash 17b are connected by the adjusting rod 33, and the operation input of the upper top rotary swash 17b is input to the upper main rotor 15 at a position advanced by the acute phase angle α, thereby changing the pitch angle.

In addition, the operation input positions of each of the upper and lower swash plates 16 and 17, and the mounting positions of the upper and lower main rotors 13 and 14 may be set to be advanced or delayed by a relatively suitable acute angle around the upper and lower main masts 16a and 16b so as to become the acute phase angle α.

According to the rotor head 7 of the R/C helicopter of this embodiment having the configuration as described above, when driving the elevator servo ES, the aileron servo AS or the pitch servo PS to move up and down the output lever 34 connected to each servo horn, in response to the position of the output lever 34 moving up and down, the lower swash plate 16 and the upper swash plate 17 are appropriately tilted around the main mast 13, and according to this, the tilting of the lower rotary swash 16b is transmitted to the lower main rotor 14 via the adjusting rod 25 to tilt the lower main rotor 14 and change the pitch angle of the lower rotor blades 14c and 14c, and the tilting of the upper top rotary swash 17b is transmitted to the upper main rotor 15 via the adjusting rod 33 to tilt the upper main rotor 15 and change the pitch angle of the upper rotor blades 15c and 15c.

Along with tilting of the upper and lower main rotors 14 and 15 and the change in the pitch angles of the rotor blades 14c and 15c, the gyro precession is applied to each of the upper and lower main rotors 14 and 15, but the gyro precession appears to be delayed within a range smaller than 90° with respect to the rotary direction of each of the upper and lower main rotors 14 and 15.

In this embodiment, as illustrated in FIG. 7(B), in response to the appearance of the gyro precession within the range smaller than 90°, the mounting positions of the upper and lower main rotors 14 and 15 are set so as to form a phase angle α smaller than 90° around the main mast 13 with respect to the input position of the cyclic control to the upper and lower main rotors 14 and 15 using the upper and lower swash plates 16 and 17, and are connected to the upper and lower main rotors 14 and 15 via a link mechanism at the input positions of each of the upper and lower swash plates 16 and 17, and the operation inputs of the upper and lower swash plates 16 and 17 are input to each of the upper and lower main rotors 14 and 15 at the position of the acute phase angle α, thereby changing the pitch angle of each of the rotor blades 14c and 15c.

Accordingly, along with the change of the pitch angles of the rotor blades 14c and 15c of each of the upper and lower main rotors 14 and 15, the direction of force of the gyro precession acting on the aircraft matches the direction for controlling the aircraft, thereby making it possible to stabilize the flight operation of the R/C helicopter.

### EXAMPLES

An industrial coaxial counter-rotating R/C helicopter equipped with the rotor head of this embodiment was constituted. The rotor blade was made of FRP, and a weight of a piece was 2 kg. The total weight of the aircraft including electrical equipment such as a motor, a receiving device, and a battery was 92 kg.

The phase angle α (a phase difference of the arrangement with respect to the operation input) illustrated in FIG. 7(B) between the operation input position of the upper and lower swash plates with respect to the upper and lower main rotors and the upper and lower main rotors was set to approximately 35°.

### Comparative Example

The upper and lower main rotors was disposed similar to the conventional R/C helicopter illustrated in FIG. 7(A) using the same aircraft and rotor blades as the above-described embodiment, that is, disposed so that the mounting positions of the upper and lower main rotors with respect to the operation input of the swash plate become a phase angle of 90°, thereby constituting the coaxial counter-rotating R/C helicopter.

When allowing the R/C helicopter of a comparative example to fly by the remote control, the operation of causing the aircraft to go straight was difficult, and behavior bent in a direction of either left or right occurred. When operating the operation stick of the transmitter to correct this, the flight attitude was lost, which makes it difficult to smoothly control the flight direction of the aircraft.

In contrast, even when the R/C helicopter of the embodiment was operated to fly in any direction of front, rear, left or right, it smoothly flew in the operation direction, and it was possible to stably control the flight direction without losing the flight attitude.

In addition, the illustrated embodiment is an example, and the present invention can be applied to the R/C helicopter of other suitable forms.

Although the invention was applied to the coaxial counter-rotating R/C in the embodiment, the invention is also applicable to a rotor head of a single rotor type R/C helicopter having a stabilizer or having no stabilizer. The invention is also applicable to a relatively large industrial R/C helicopter, a hobby R/C helicopter flying outdoors, or an indoor compact and lightweight R/C helicopter.

1. A rotor head of a remote control helicopter that flies by changing an angle of attack of rotor blades of a main rotor attached to a main mast by performing a tilting operation of a swash plate by a wireless remote control,
wherein the main rotor is provided so that gyro precession of a main rotor serving as an output with respect to an operation input from the swash plate appears within a range smaller than 90°, and
the rotor head has a configuration in which a mounting position of the main rotor is provided at an angle smaller than 90° around the main mast with respect to an input position of a cyclic control to the main rotor using the swash plate, and the main rotor and the swash plate are connected via a link mechanism so that an angle of intersection in a plan view between a line segment in a long axis direction of the main rotor and a position of the operation input of the swash plate that is input via the link mechanism connected to the main rotor becomes an acute phase angle α.

2. A rotor head of a coaxial counter-rotating remote control helicopter in which upper and lower main rotors are attached to a rotary shaft provided on a main mast and coaxially counter-rotating to each other, and which flies by changing an angle of attack of rotor blades of the upper and lower main rotors by performing a tilting operation of each of upper and lower swash plates by a wireless remote control,
wherein the upper and lower main rotors are provided so that gyro precession of the respective main rotors serving as an output with respect to an operation input from the upper and lower swash plates appears within a range smaller than 90°, and
the rotor head has a configuration in which mounting positions of the upper and lower main rotors are provided to an angle smaller than 90° around the main mast with respect to the input positions of each of cyclic controls of upper and lower main rotors using the upper and lower swash plates, and the upper and lower main rotors and the upper and lower swash plates are connected via a link mechanism, respectively so that an angle of intersection in a plan view between line segments of a long axis direction of each of upper and lower main rotors and a position of the operation inputs of the upper and lower swash plates that are input via the link mechanism connected to each of the upper and lower main rotors becomes an acute phase angle α, respectively.

3. A remote control helicopter equipped with the rotor head according to claim 1.

4. A remote control helicopter equipped with the rotor head according to claim 2.
